(19) United States
(12) Patent Application Publication
(10) Pub. No.: US 2007/0179795 A1
(43) Pub. Date: Aug. 2, 2007

(54) Method and system for globalization of business processes

(75) Inventors: Elena M. Ordonez, Schwetzingen (DE); Michael Depner, Sinsheim (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/341,514

(22) Filed: Jan. 30, 2006

(51) Int. Cl. G06Q 99/00

(52) U.S. Cl. 705/1

(57) ABSTRACT

Embodiments of the present invention relate to a method and system wherein a globalization component of software is decoupled from an overall business software platform. The decoupling allows changes required by the frequently-evolving and unpredictable environment of international regulation to be more quickly and easily made than in the past, and without destabilizing underlying core functionality. Embodiments of the present invention further relate to a method and system wherein an industry component of software is decoupled from an overall business software platform. In this way, the stability of core business logic is not affected by changes in industry solution logic. The decoupling further enables country-specific and industry-specific logic to be easily adaptable to new markets and industries, because the same underlying infrastructure can be re-used for different markets and industries.

### BACKGROUND OF THE INVENTION

The spread of global connectivity by way of electronic networks such as the Internet has fueled a phenomenon sometimes called “globalization.” With globalization, business services may flow freely via computer networks across national borders transparently to users of the services. However, behind the scenes, national laws are still in force and businesses must be compliant with these laws.

Most businesses these days rely heavily on computers and software. The computers and software may execute business processes electronically, collecting, manipulating, generating, and storing information for many different purposes. In many applications, the international aspects of business software—in particular, those related to compliance with various national regulations—have traditionally been tightly coupled to or integrated with the overall software. For example, tax calculations or employee-related operations that might be dictated by a specific country's laws would be embedded within a tax reporting or payroll application and linked to the overall logic flow of the application. This has meant that when the country-specific regulations have changed, remaining compliant has required drilling down into core application logic to make the necessary changes. Because changes in legal requirements per country can be frequent and unpredictable, accounting for these changes in software has often been costly in terms of time and coding effort, and destabilizing to core functionality.

Similarly, industry-specific logic has traditionally been integrated into core application logic. “Industry” as used here means a field of business endeavor; thus, the term could cover anything, for example, from manufacturing to purely service businesses, such as banking. Because industry-specific logic has been tightly coupled to core application logic, it has been difficult in the past to adapt the logic to changing markets and customers. As with country-specific logic, adapting industry-specific logic to changing circumstances has been time-consuming, laborious and destabilizing to core logic.

A further challenge that has confronted software developers and providers involves reusability. That is, usually designing and coding a software package of any significance requires a considerable investment of time and effort, and as a result often the package contains a number of ingenious solutions. However, because these solutions are typically integrated with the overall package, it is difficult to reuse the solutions for other projects where they might be equally applicable. Instead, typically developers must “start from scratch” on new projects, letting past work, in effect, go to waste.

### BRIEF DESCRIPTION OF THE DRAWINGS

FIGS. 1 and 2 show a software architecture including a globalization layer according to embodiments of the present invention;

FIGS. 3 and 4 show a software architecture including an industry layer according to embodiments of the present invention;

FIG. 5 shows a software architecture including both a globalization layer and an industry layer according to embodiments of the present invention;

FIG. 6 shows various modes of accessing either the globalization layer or the industry layer;

FIG. 7 shows technology and other layers supplementing the software architectures;

FIG. 8 shows a network configuration wherein embodiments of the present invention may find advantageous application;

FIG. 9 shows a business process accessing a globalization layer according to embodiments of the present invention;

FIG. 10 shows a business process accessing an industry layer according to embodiments of the present invention; and

FIG. 11 shows a method according to embodiments of the present invention.

### DETAILED DESCRIPTION

Embodiments of the present invention address the above-noted concerns. The embodiments relate to a method and system wherein a globalization component of software is decoupled from an overall business software platform. The decoupling allows changes required by the frequently-evolving and unpredictable environment of international regulation to be more quickly and easily made than in the past, and without destabilizing underlying core functionality. Embodiments of the present invention further relate to a method and system wherein an industry component of software is decoupled from an overall business software platform. In this way, the stability of core business logic is not affected by changes in industry solution logic.

Furthermore, the decoupling of the globalization and industry components addresses the reusability issue. The decoupling enables country-specific and industry-specific logic to be easily adaptable to new markets and industries, because the same underlying infrastructure can be used for different markets and industries. This eliminates the need to develop new solutions for different markets and industries “from scratch.” Instead, globalization and industry components can be developed just once and then re-used.

The globalization component and the industry component are not mutually exclusive and may both be present in the same software architecture. Both the globalization component and the industry component may be utilized by a business process. The business process may access country-specific functionality of the globalization component, or industry-specific functionality of the industry component, or both, to meet requirements of the business process.

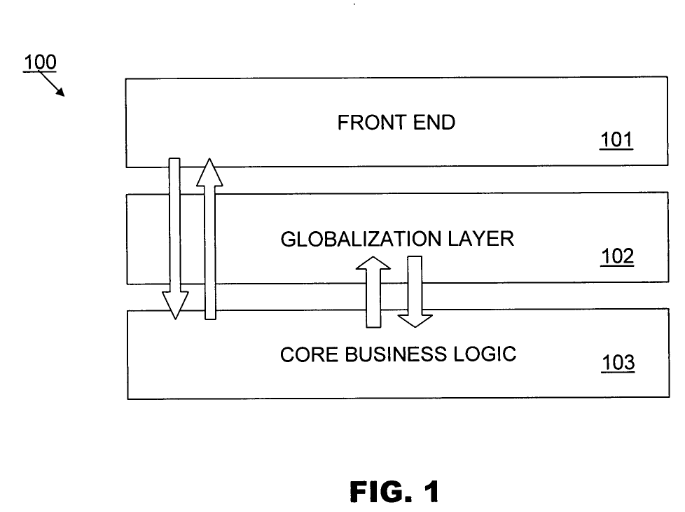

FIG. 1 shows a software architecture 100 according to embodiments of the present invention. The architecture comprises a front end 101 and core business logic 103. The core business logic 103 may include business logic of many and varied types, such as applications relating to sales, billing, taxes, personnel and accounting. The front end 101 may comprise user interfaces and configuration functionality. The globalization layer 102 is a discrete software layer, decoupled from front end and core business logic. The globalization layer may comprise country-specific logic not present in the core business logic.

A user having need of functionality in the core business logic 103 may access the functionality via the front end 101. For example, the user may execute a business process that accesses the core business logic. For some business processes, the core business logic may be able to provide all of the functionality needed by the business process. However, some business processes may require country-specific logic, for example to meet country-specific legal requirements. According to embodiments of the present invention, if it is determined that a business process requires country-specific logic, the globalization layer may be accessed to utilize country-specific logic therein.

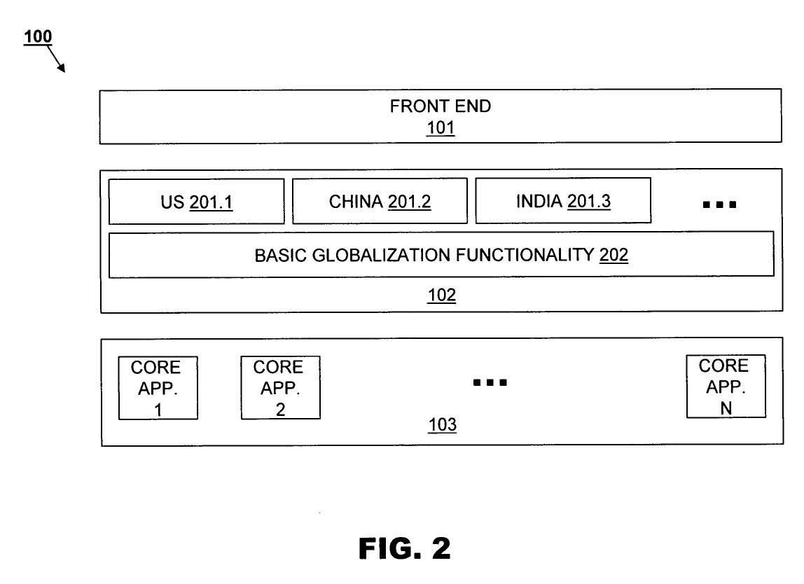

Referring to FIG. 2, the globalization layer 102 may comprise a plurality of country-specific components 201.k, such as a component for the United States 201.1, for China 201.2, for India 201.3 and so on. The country-specific components may relate, for example, to legal requirements within a given country. The globalization layer may further comprise basic globalization functionality 202. The basic globalization functionality may include functionality that is subject to legal changes (and thus part of the globalization layer), but that is common to all or many countries.

The core business logic 103 may include a plurality of core applications 1-N. As noted previously, these may encompass a wide range of types and functionality. The functionality may be generic, so that it can be tailored to suit various users. For example, a core application J may be a generic “Invoice” application. A user at the front end may, for example via user-specific configuration values, adapt this generic Invoice application to the user's specific needs. When the Invoice functionality is able to provide what is needed, it may do so. However, if for example the user's business process needs to calculate a country-specific tax, for, say, India, the India-specific component 201.3 component in the globalization layer 102 may be accessed for this purpose. After this country-specific requirement is met, it may be the case that the functionality of the core business logic is able to meet subsequent requirements, and the business process may continue, utilizing only the core business logic. Then, it may be that another country-specific requirement is encountered, and the globalization layer may be accessed and only functionality of that layer utilized. Interaction between the core business logic and the globalization layer may proceed in this way until all the requirements of a business process are met.

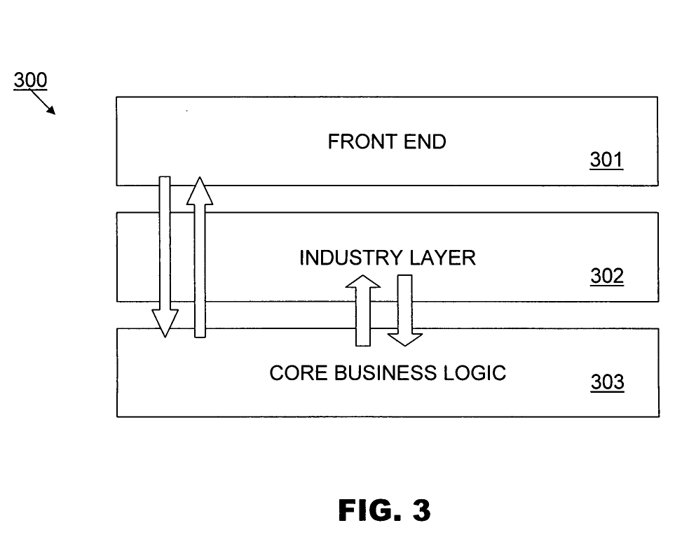

FIG. 3 shows another architecture 300 according to embodiments of the present invention. The architecture is in respects similar to the architecture 100. The architecture 300 comprises a front end 301 and core business logic 303. These may operate in substantially the same way as the front end 101 and core business logic 103 discussed previously. However, the architecture 300 comprises a discrete industry layer 302, as opposed to a globalization layer 102, decoupled from the front end and the core business logic. The industry layer may comprise industry-specific logic.

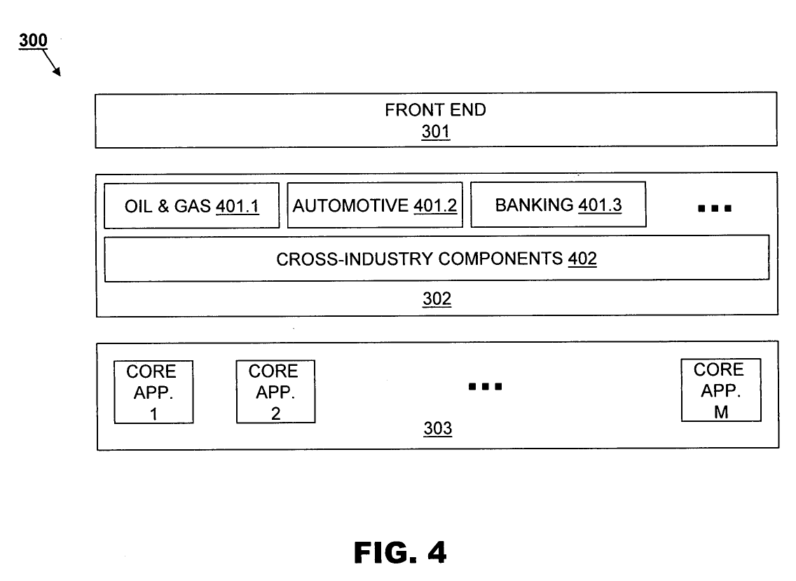

Referring to FIG. 4, the industry layer 302 may comprise a plurality of industry-specific components 401.k, such as a component for the oil and gas industry 401.1, for the automotive industry 401.2, for the banking industry 401.3 and so on. The industry-specific components may relate, for example, to particular industry practices, standards, requirements and the like. The industry layer may further comprise cross-industry components 402 that are subject to change, but that are common to all or many industries.

Along lines discussed in connection with the globalization layer, the core business logic 303 may include a plurality of core applications 1-M. For example, a core application K may be a generic “Sales Order” application. A user at the front end, for example a user in the oil and gas business, may adapt this generic Sales Order application to the user's specific needs. When the Sales Order functionality is able to provide what is needed, it may do so. However, if for example the user's business process needs to perform an industry-specific operation, such as calculating a quantity at a standard temperature, the oil and gas component in the industry layer 302 may be accessed for this purpose. After this industry-specific requirement is met, it may be the case that the functionality of the core business logic is able to meet subsequent requirements, and the business process may continue, utilizing only the core business logic. Then, it may be that another industry-specific requirement is encountered, and the industry layer may be accessed and only functionality of that layer utilized. Interaction between the core business logic and the industry layer may proceed in this way until all the requirements of a business process are met.

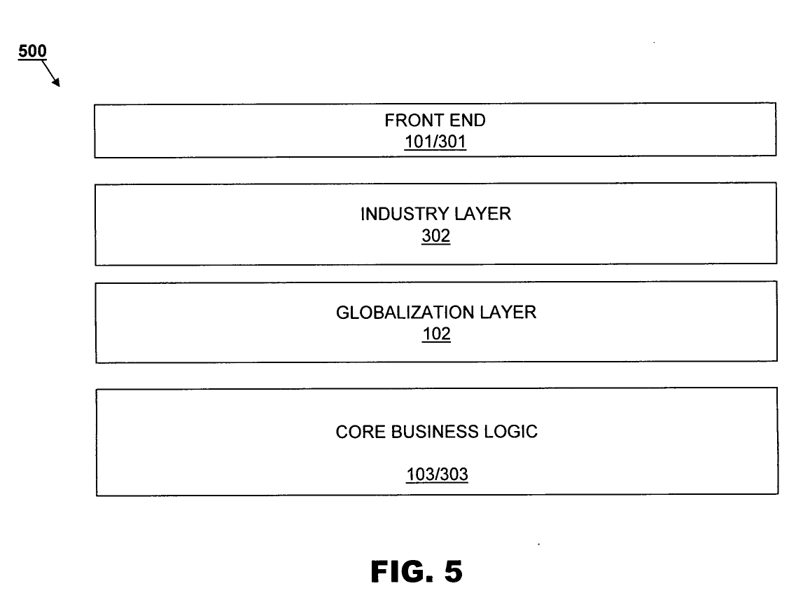

In the architectures 100 and 300, the globalization layer 102 and industry layer 302 are not mutually exclusive, as noted previously. Both may be present in the same architecture, as shown in FIG. 5. In an architecture 500 as shown in FIG. 5, interaction between a core business logic layer 103/303 and both a globalization layer 102 and an industry layer 302 may take place as described above.

Embodiments of the invention may include object-oriented functionality. As is known, a software object may represent various relationships among data, classes, interfaces, methods, services and other object-oriented concepts. Linkages may be formed between objects. Though it is typically transparent to the object-oriented programmer, in embodiments objects may be implemented at least in part as tables comprising a plurality of modifiable entries that collectively exhibit the behavior that characterizes an object and that can logically link objects.

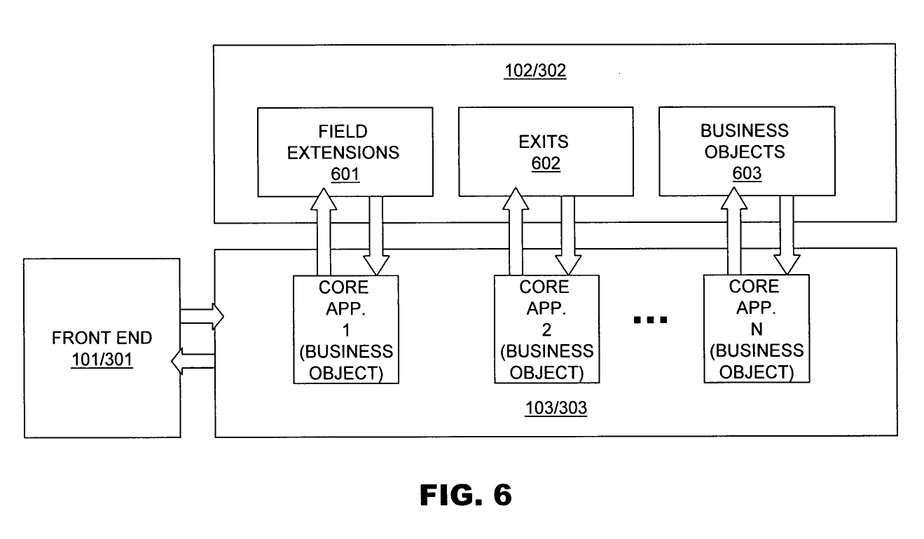

Referring now to FIG. 6, functionality of the globalization layer or the industry layer may be accessed in various ways. FIG. 6 shows a front end 101/301 accessing functionality of core business logic 103/303. In the core business logic 103/303, core applications may be implemented as business (software) objects. A decoupled layer 102/302 corresponds to either a globalization layer or an industry layer. Embodiments of the present invention may extend functionality of the core business logic by mechanisms including field extensions 601, special exits 602, or business objects 603, provided exclusively by the decoupled layer 102/302.

For example, for some business processes, all that is needed from the globalization or industry layer is data. This data may be obtained as field extensions of existing fields in the underlying core business logic. For example, a special number field might need to be added to an invoice for a given country. According to embodiments of the invention, this special field exists only in the decoupled layer 102/302. When the special field is needed, a corresponding field extension 601 in the decoupled layer 602 may be accessed to obtain the special field. The underlying data in the core business logic 103/303 may be extended by the special field.

In other business processes, functionality of the core business logic may need to be extended beyond mere acquisition of fields. For example, special tax calculations may need to be performed for a given country. Thus, embodiments of the invention may further comprise accessing extended functionality in the decoupled layer 102/302 by way of special exits 602. In embodiments, the exits may be implemented as class extensions. As is known in the field of object-oriented programming, in a class extension, methods may be extended by pre- and post-exits. To utilize the exits, the core business logic may call exits 602 in the decoupled layer, identifying actions to be performed. The actions could include, for example, modifying data, performing calculations, or the like—whatever is needed to satisfy a particular country-specific or industry-specify phase of a business process.

In still other business processes, still more complicated functionality may be required of the decoupled layer 102/302. Accordingly, embodiments of the invention may further comprise extending functionality of objects in the core business logic using either existing objects 603 in the decoupled layer, or by creating altogether new business objects 603 in the decoupled layer. The core business logic 103/303 may link to the existing objects or to new objects in the decoupled layer and communicate with them to obtain functionality needed for a given business process.

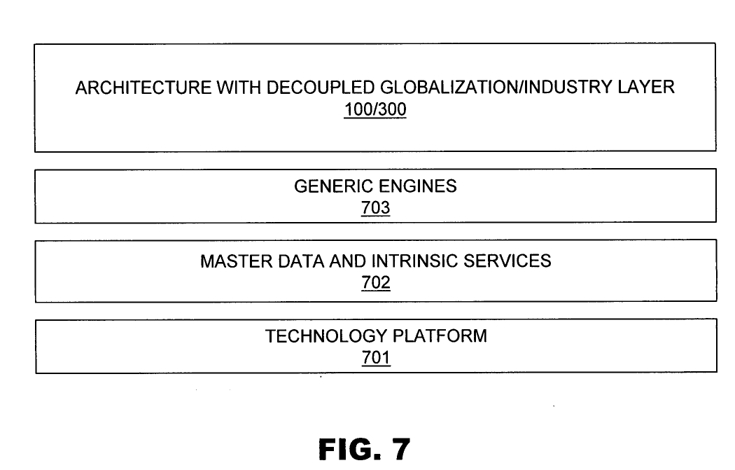

Referring now to FIG. 7, the architectures 100 or 300 may be supplemented by additional components. For example, the architectures may include a technology platform 701. The technology platform may comprise hardware and software for providing basic functionality, such as computers including processors and memory, data storage devices such as disk, network equipment for connectivity, and so on, along with the associated firmware or software. The technology platform 701 may support a Master Data and Intrinsic Services layer 702. Above this layer may be an Engines layer 703 comprising generic computing engines for, e.g., tax calculations, accounting calculations, payroll calculations, and the like.

As noted previously, the core business logic may interface with front end components 101, 301. These front end components may reflect particular customer “solutions,” i.e., software packages developed for particular customers or customer sites, for particular industries, for market segments such as small businesses, medium-sized business, large enterprises, and so on.

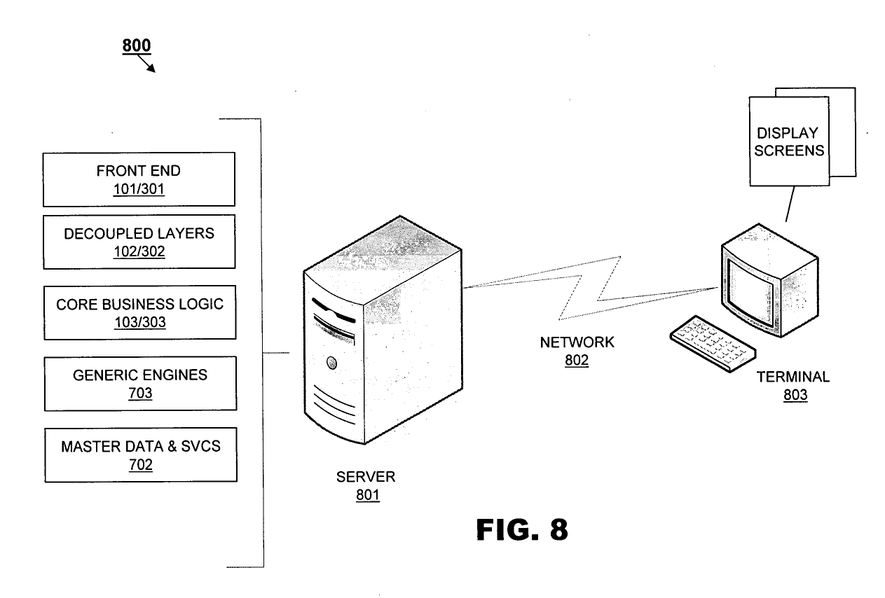

Embodiments of the present invention may be network based. FIG. 8 shows an example of a computer and network configuration 800 that may be used to practice the embodiments. Software according to embodiments of the present invention, including, for example, the master data and intrinsic services 702, the generic engines 703, the core business logic 103/303, the decoupled layer(s) 102/302, and the front end 101/301, may reside on one or more server computers 801. The server computer(s) may be connected by a network 802 to terminals 803. The network may include or be part of the Internet, but could further include or be part of any LAN (local area network) or WAN (wide area network).

The terminals 803 may be located, for example, at a customer site (i.e., at the front end). Users at customer sites may perform computerized business processes via the network 802, using a terminal 803 to connect to the network. In the performance of the business processes, functionality of the software architectures 100/300 according to embodiments of the present invention may be accessed via the network 802. For example, a user may enter commands at a terminal 803 that causes a software-implemented business process comprising one or more potential logic paths and associated decision points to be executed. The business process may access the functionality of the software architecture 100/300 via the network, initially accessing some particular customer solution in the front end 101/301, but subsequently, accessing functionality of other layers of the architecture 100/300. In particular, if the business process has country-specific requirements or industry-specific requirements, the globalization layer 102 or industry layer 302, or both, may be accessed. During the course of executing the business process, display screens and prompts generated by the software architecture 100/300, corresponding to the logical pathways taken by the business process, may be sent via the network to the terminal 803. User inputs responsive to the display screens and prompts may, in turn, be sent via the network to the server(s) 801 for processing by the functionality of the software architecture 100/300.

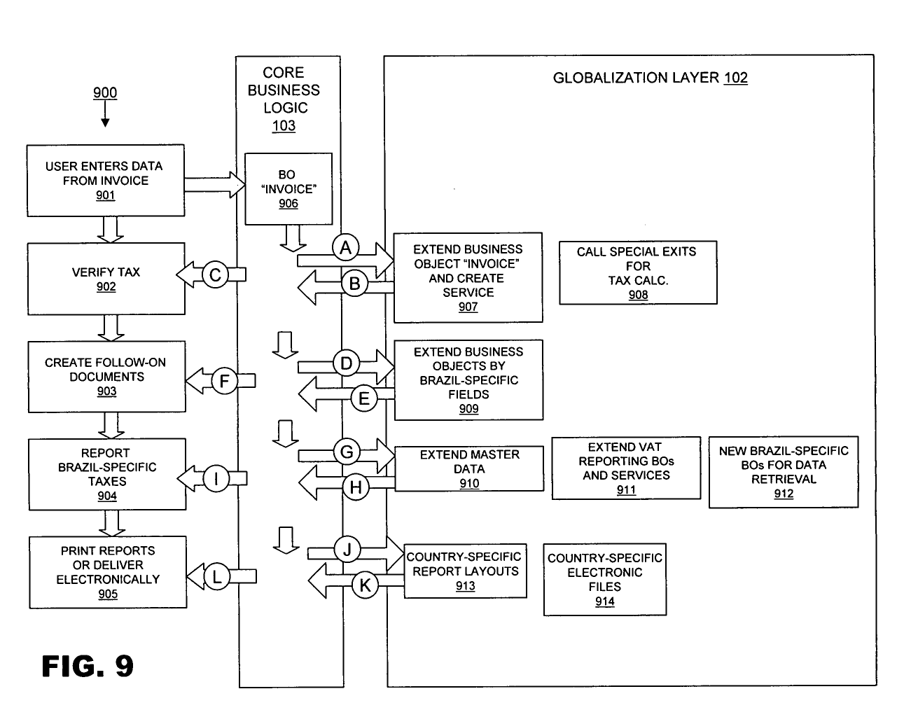

FIG. 9 shows an example of a business process 900 according to embodiments of the present invention. Execution of the business process 900 involves accessing functionality of the globalization layer to meet country-specific requirements of the business process 900. Solely for purposes of illustration, the country is Brazil, and the business process is generating and reporting on an invoice.

As shown in block 901, a user may enter data from an incoming invoice. To this end, a user interface may be provided. The user interface may correspond to a component of the front end, e.g. a particular customer solution. The user interface may include, for example, generic screen displays modified or extended for a particular customer solution.

Initially, the business process may access functionality, such as a business object “Invoice” 906, in the core business logic 103. As the business process 900 goes forward, decision points may arise. For example, based on the identification of the business process as corresponding to a particular country, it may be determined whether functionality of the globalization layer 102 is required. In this example, it is determined that for the country in question, Brazil, a “Verify Tax” operation 902 of the business process requires Brazil-specific functionality that exists only in the globalization layer 102. Accordingly, at point A, the core business logic 103 calls the globalization layer 102. The globalization layer 102 extends the Invoice business object, possibly creating a new service or services (block 907). The core business logic may further call a special exit for a tax calculation (block 908). The results of the functionality performed by the globalization layer may be (B) returned to the core business logic and (C) used to satisfy the requirements of the business process operation Verify Tax 902.

The business process 900 may further involve creating follow-on documents, as shown in block 903. Again, for this operation, it may be determined whether functionality of the globalization layer is needed. If so, the globalization layer 102 may (D) be accessed. To meet the needs of the operation of process block 903, functionality of the globalization layer may extend the associated business objects by Brazil-specific fields (block 908). Results may be (E) returned to the core business logic and (F) used to satisfy the requirements of the business process operation Create Follow-on Documents 903.

Business process 900 may further include reporting Brazil-specific taxes. For this purpose, as shown in process block 904, functionality in the globalization layer may be called (G) to extend master data (block 910), extend VAT (value added tax) reporting business objects (block 911) and create new Brazil-specific business objects for data retrieval (block 912). Results may be (H) returned to the core business logic and (I) used to satisfy the requirements of the business process operation Report Brazil-Specific Taxes 904.

Processing an invoice may further require printing reports or delivering reports electronically. Accordingly, the business process 900 may further include (J) accessing functionality of the globalization layer to format printed reports or electronic reporting files according to Brazil-specific requirements (e.g. using field extensions) (blocks 913 and 914). Results may be (K) returned to the core business logic and (L) used to satisfy the requirements of the business process operation 905.

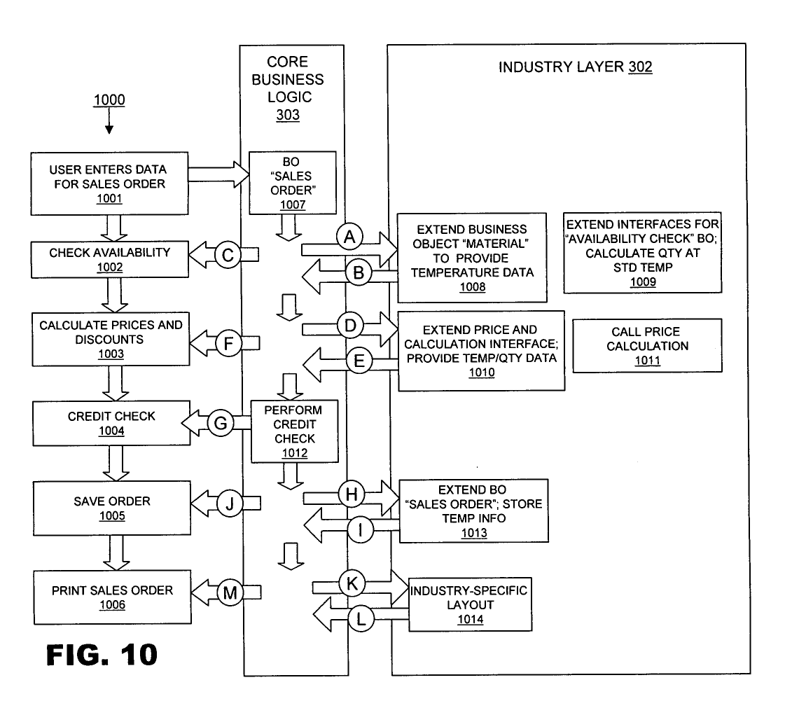

FIG. 10 shows an example of a business process 1000 that utilizes an industry layer 302. Solely for purposes of illustration, the example relates to the oil and gas industry. As shown in block 1001, a user may enter data for a sales order. Initially, the business process may access functionality, such as a business object “Sales Order” 1006, in the core business logic 303. As the business process 1000 goes forward, a “Check Availability” operation 1002 may need to be performed. It may be determined that operation 1002 requires functionality of the industry layer 302. Accordingly, at point A, the core business logic 303 calls the industry layer 302. The industry layer 302 extends a business object “Material” to provide temperature data (block 1008), and extends interfaces of an “Availability Check” business object and calculates a quantity at a standard temperature (block 1009). The results of the functionality performed by the industry layer may be (B) returned to the core business logic and (C) used to satisfy the requirements of the business process operation Check Availability 1002.

A next operation of business process 1000 is a “Calculate Prices and Discounts” operation 1003. It may be determined that operation 1003 requires functionality of the industry layer 302. Accordingly, at point D, the core business logic 303 calls the industry layer 302. The industry layer 302 extends interfaces of a “Price and Tax Calculation” business object and provides the object the temperature and quantity information obtained previously (block 1010). A price calculation may then be called, for example by way of a special exit (block 1011). The results of the functionality performed by the industry layer may be (E) returned to the core business logic and (F) used to satisfy the requirements of the business process operation Calculate Prices and Discounts 1003.

A next operation of business process 1000 is a “Credit Check” operation 1004. This is an example of an operation that does not require the industry layer 302. Instead, a business object in the core business logic 303 simply performs the credit check (block 1012) to (G) satisfy the requirements of the business process operation Credit Check 1004.

A next operation of business process 1000 is a “Save Order” operation 1005. It may be determined that operation 1005 requires functionality of the industry layer 302. Accordingly, at point H, the core business logic 303 calls the industry layer 302. The industry layer 302 extends fields of the Sales Order business object to store temperature information (block 1013).

Finally, the business process 1000 may further include (K) accessing functionality of the industry layer to format a printed sales order (could be electronic) according to oil-and-gas-specific requirements (e.g. using field extensions) (block 1014). Results may be (L) returned to the core business logic and (M) used to satisfy the requirements of the business process operation “Print Sales Order” 1006.

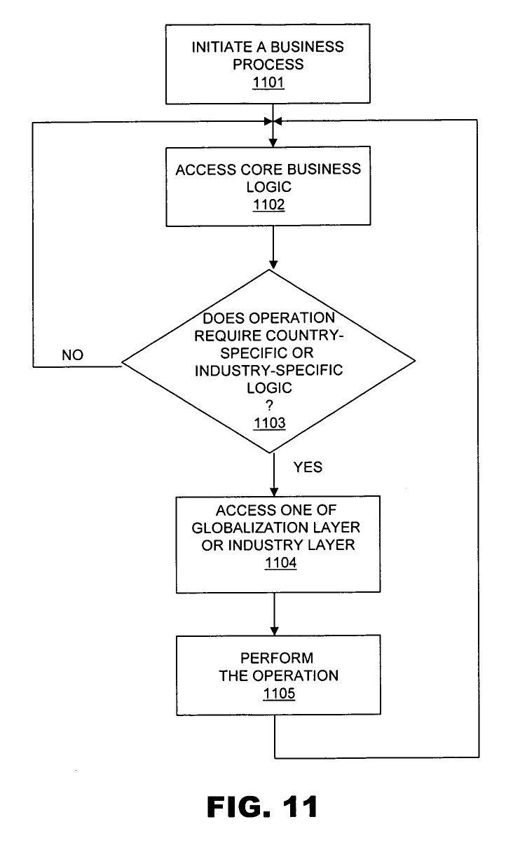

In view of the above description, FIG. 11 shows a method according to embodiments of the present invention. As shown in block 1101, the method may comprise initiating a business process. The process may include accessing functionality of a layer of core business logic to perform an operation of the business process, as shown in block 1102.

The method may further include determining whether the operation requires country-specific logic or industry-specific logic not present in the core business logic, as shown in block 1103. If not, the business process may continue using the core business logic. However, if so, the method may further include accessing one of a discrete globalization layer, separate from the core business logic and including the country-specific logic required by the operation, or a discrete industry layer, separate from the core business logic and including the industry-specific logic required by the operation, as shown in block 1104. The country-specific logic or the industry-specific logic may be used to perform the operation, as shown in block 1104. The method may further include continuing the business process, which may involve returning to the core business logic.

A computer program or collection of programs comprising computer-executable instructions according to embodiments of the present invention may be stored on machine-readable media such as disk. Such media, as is known, may be incorporated into a server computer. The computer-executable instructions may be distributed across a plurality of media, such as on physically separate storage devices respectively associated with physically separate computer systems that may communicate via a network. The instructions when executed may perform functionality according to embodiments of the present invention. The functionality disclosed hereinabove may find specific implementations in a variety of forms, which are considered to be within the abilities of those of ordinary skill in the pertinent art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
executing a business process; and
accessing a globalization layer comprising country-specific functionality to meet requirements of the business process.

2. The method of claim 1, wherein the requirements include country-specific legal requirements.

3. The method of claim 1, wherein accessing the globalization layer includes performing a country-specific field extension.

4. The method of claim 1, wherein accessing the globalization layer includes executing country-specific functionality within the globalization layer.

5. The method of claim 1, wherein accessing the globalization layer includes extending an object in the globalization layer.

6. A method comprising:
executing a business process; and
accessing an industry layer comprising industry-specific functionality to meet requirements of the business process.

7. The method of claim 8, wherein accessing the industry layer includes performing an industry-specific field extension.

8. The method of claim 6, wherein accessing the industry layer includes executing industry-specific functionality within the industry layer.

9. The method of claim 6, wherein accessing the industry layer includes extending an object in the industry layer.

10. A method comprising:
initiating a business process;
accessing functionality of a layer of core business logic to perform an operation of the business process;
determining that the operation requires one of country-specific logic or industry-specific logic not present in the core business logic; and
accessing one of a discrete globalization layer, separate from the core business logic and including the country-specific logic required by the operation, or a discrete industry layer, separate from the core business logic and including the industry-specific logic required by the operation; and
using the country-specific logic or the industry-specific logic to perform the operation.

11. The method of claim 10, wherein accessing the globalization layer or the industry layer includes performing a country-specific or an industry-specific field extension.

12. The method of claim 10, wherein accessing the globalization layer or the industry layer includes executing country-specific functionality within the globalization layer or industry-specific functionality within the industry layer.

13. The method of claim 10, wherein accessing the globalization layer or the industry layer includes extending an object in the globalization layer or the industry layer.

14. A machine-readable medium storing computer-executable instructions to perform the method of claim 10.

15. A system comprising:
a software architecture including a front end, a core business logic layer, and at least one of a discrete globalization layer or industry layer separate from the core business logic layer and the front end, the globalization layer including country-specific logic and the industry layer including industry-specific logic;
a network of computers to connect the front end, the core business logic layer, and the at least one of a discrete globalization layer or industry layer;
wherein the front end is to initiate a business process, the business process accessing functionality of the core business logic layer to perform an operation, and if it is determined that the operation requires one of country-specific logic or industry-specific logic not present in the core business logic, the business process accessing one of the globalization layer or the industry layer to perform the operation.

16. The system of claim 10, wherein the network includes or is part of the Internet.

17. The system of claim 10, wherein the country-specific logic relates to legal requirements of a country.
